(19) United States
(12) Patent Application Publication
(10) Pub. No.: US 2025/0240290 A1
(43) Pub. Date: Jul. 24, 2025

(54) Authentication using sequence of facial images

(71) Applicant: DigiCert, Inc., Lehi, UT (US)

(72) Inventor: Supratik Mondal, Bangalore (IN)

(73) Assignee: DigiCert, Inc., Lehi, UT (US)

(21) Appl. No.: 18/600,670

(22) Filed: Mar. 9, 2024

(30) Foreign Application Priority Data
Jan. 24, 2024 (IN) 202441004887

(51) Int. Cl. H04L 9/40; G06V 40/16

(52) U.S. Cl. CPC H04L 63/0861; G06V 40/167; H04L 63/0823

(57) ABSTRACT

Systems and methods are provided for authenticating a user to enable a user device to gain access to a user account on a secure website. A user authentication method, according to one implementation, includes a step of capturing multiple facial images of a user associated with the user device and user account. The user authentication method further includes a step of comparing the multiple facial images with a sequence of pre-stored facial expressions. Upon detection that the multiple facial images adequately match the pre-stored facial expressions, the user authentication method also includes a step of providing an instant digital certificate to the secure website for gaining access to the user account.

### FIELD OF THE DISCLOSURE

The present disclosure relates generally to network security and digital certificates. More particularly, the present disclosure relates to systems and methods for authenticating user credentials using a sequence of facial expression images.

### BACKGROUND

Network security is an important issue that affects the everyday lives of most people. Gaining access to certain websites, such as banking websites, usually involves some type of authentication process to ensure that only account owners are able access their respective accounts. One such authentication process is the One-Time Password (OTP) procedure, which involves the secure website sending an OTP to a registered account holder, such as via a text message on the account holder's mobile phone. The account holder can then type the OTP into a login field to gain access to the account. Although the OTP procedure is acceptable in many circumstances, this process still has its shortcomings. For instance, there may be times when a user attempts to log in to the website but his or her mobile phone is not on hand. At other times, the user may wish to quickly purchase a product or ticket having limited availability and the OTP procedure may be too slow. In still other scenarios, a hacker may be able to get around certain OTP procedures. Therefore, there is a need to provide authentication methods that can improve the process of logging onto a secure website.

### BRIEF SUMMARY

The present disclosure relates to systems and methods for authenticating a user to enable a user device to gain access to a user account on a secure website. A user authentication process, according to some implementations, includes a step of capturing multiple facial images of a user associated with the user device and user account. The user authentication process further includes a step of comparing the multiple facial images with a sequence of pre-stored facial expressions. Upon detection that the multiple facial images adequately match the pre-stored facial expressions, the user authentication process includes a step of providing an instant digital certificate to the secure website for gaining access to the user account. In some embodiments, the user authentication process may be performed in lieu of a one-time password procedure conducted between the secure website and user device.

According to various embodiments of the user authentication process, the pre-stored facial expressions may be captured during a set-up procedure. The set-up procedure, for example, may enable the user to select a number of images to be included in the sequence and a type of facial expression for each image. In some implementations, the set-up procedure includes coordination among a Certificate Authority, the user device, and the secure website. The Certificate Authority, for example, may be configured to a) onboard the secure website to enable facial authentication processing, b) issue a device certificate to the user device, and c) load a facial authentication application on the user device to enable the facial authentication processing with the secure website. The set-up procedure may further enable the user to create multiple security passcodes, where each security passcode may include a different number and/or sequence of images. Also, the multiple security passcodes enable the user to open the user device itself as well as access one or more secure websites. The set-up procedure may further enable the user to bind personal information with the user account during a registration procedure, where the personal information may include one or more of a mobile number and an email address.

Furthermore, the user authentication process according to various embodiments may be configured such that a trusted Certificate Authority may be configured to download an authentication application to the user device to enable the user device to a) capture the sequence of pre-stored facial expressions during a set-up procedure, and b) capture the multiple facial images during a login procedure. The authentication application may further enable the user device to c) compare the multiple facial images with the sequence of pre-stored facial expressions, d) detect whether the multiple facial images adequately match the pre-stored facial expressions, and e) provide the instant digital certificate to the secure website.

The user authentication process may further include the steps of a) collecting information regarding successful and unsuccessful attempts to access the user account, and b) analyzing the information to detect malicious behavior. In some embodiments, the step of capturing multiple facial images of the user may include capturing a video of the user to determine that the user is a real person. Therefore, the step of comparing the multiple facial images with the sequence of pre-stored facial expressions may include the steps of a) comparing multiple images extracted from the video with each pre-stored facial expression until a match is detected, and b) repeating the comparing step with a next pre-stored facial expression in the sequence until all pre-stored facial expressions are matched.

The user authentication process contemplates implementation as a method having steps, via a processing device in a smart device configured to implement the steps, and via a non-transitory computer-readable medium storing instructions for programming one or more processors to execute the steps.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram illustrating a communication system in which users can securely access online servers, according to various embodiments.

FIG. 2 is a block diagram illustrating the trusted system shown in FIG. 1, according to various embodiments.

FIG. 3 is a block diagram illustrating any one or more of the user devices shown in FIG. 1, according to various embodiments.

FIG. 4 is a block diagram illustrating any one or more of the secure online terminals shown in FIG. 1, according to various embodiments.

FIG. 5 is a flow diagram illustrating an overall security process for setting up a facial identification system, authenticating a user with the facial identification system, and auditing to determine the effectiveness of the facial identification system, according to various embodiments.

FIGS. 6A-6I are images of a user illustrating a number of different facial expressions used for creating one or more facial authentication passcodes, according to various embodiments.

FIGS. 7A and 7B are combinations of different facial expressions for creating different facial authentication passcodes, according to various embodiments.

FIGS. 8A and 8B are diagrams illustrating login fields for performing different types of authentication procedures, according to various embodiments.

FIG. 9 is a flow diagram illustrating a method for authenticating a user for accessing a secure website, according to various embodiments.

### DETAILED DESCRIPTION

Again, the present disclosure relates to systems and methods for enabling a user to securely access an account on a website using a facial identification authentication strategy. In some embodiments, the facial identification process may be used in place of a One-Time Password (OTP) strategy. In other embodiments, however, the facial identification process may be used in addition to an OTP strategy for greater security.

OTPs (also known as one-time PINs, one-time authorization codes, dynamic passwords, two-factor authentication passwords, etc.) are passwords that are valid for only one login session or transaction and are effective for only a limited time (e.g., 5 minutes). OTPs are considered to be an improvement over traditional (static) password-based authentication and involves utilization of another user device, such as a key fob, mobile phone, smartcard, etc. The generation of the OTP characters (e.g., numbers) usually involves pseudo-random algorithms to generate a shared key, seed, and cryptographic hash function, which can be used to derive a value that is difficult to reverse or hack. A shortcoming of OTPs, however, is that they can be intercepted or rerouted, related user devices and tokens can be lost, stolen, or damaged. Also, attackers can still retrieve the OTPs through phishing attacks or by impersonating the authorized user.

In addition, the OTP procedures are often not fast enough for users in some cases. For example, a user may wish to quickly purchase tickets (e.g., concert tickets, movie tickets, train tickets, plane tickets, etc.) that are in high demand, or the user may wish to quickly purchase products in a “flash” sale (e.g., purchasing an iPhone of limited stock) on an e-commerce website. However, by the time the user receives the OTP and entered the OTP into the specific input field (e.g., for approval of payment), the ticket or product may already be sold out.

In some high-security situations, a secure website may require various forms of authentication to verify that the user is indeed a valid person who is authorized to perform some action online (e.g., enter a secure website, access an account, purchase a product, transfer funds, etc.). These secure sites may use multi-stage authentication strategies, which can be complex, time-consuming, and frustrating for the average user. As a result, the users in these cases can have a negative experience. In addition to OTP authentication, other strategies may be used, such as Captcha-based validation screens, multiple image recognition pages to prove that the user is not a robot, deciphering and typing in cryptic validation characters, various forms of identification, questions about mother's maiden name or pet name, etc.

### User Authentication System

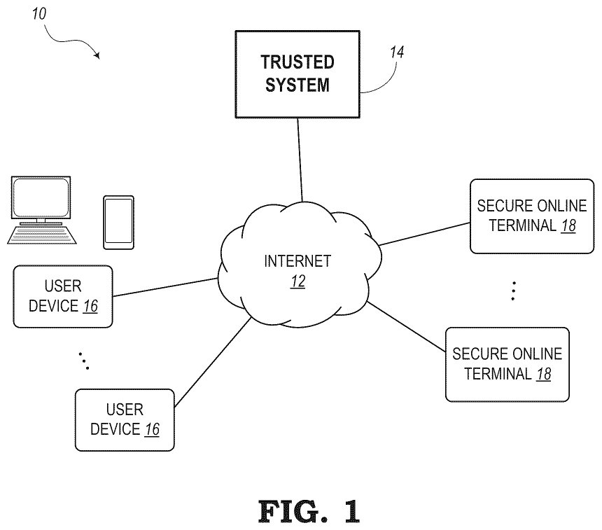

FIG. 1 is a block diagram illustrating an embodiment of a user authentication system 10, which may be a cloud-based communication system, in which users can be authenticated to securely access online servers. As shown in FIG. 1, the user authentication system 10 includes the Internet 12 or other network over which communication signals, data packets, information, etc. can be propagated over wired and/or wireless channels. The user authentication system 10 includes a trusted system 14 (e.g., a Certificate Authority) that is configured to issue digital certificates, signed certificates, device certificates, website certificates, and the like. Also, the user authentication system 10 includes a plurality of user devices 16 (e.g., personal computers, laptop computers, tablets, mobile phones, smart phones, etc.), each of which is configured to access the Internet 12 via any suitable combination of wired and/or wireless media. Furthermore, the user authentication system 10 includes a plurality of secure online terminals 18, which may be associated with secure websites or servers (e.g., banking servers, financial transaction servers, product purchasing servers, etc.) in which a certain level of security might be expected to ensure that only legitimate users, such as those associated with the user devices 16, are able to access the secure online terminals 18 (and websites and servers thereof) and/or to access user accounts associated with the secure online terminals 18.

In a typical One-Time Password (OTP) operation, a user who is using one of the user devices 16 may attempt to log onto, enter, or access one of the secure online terminals 18 to retrieve or observe sensitive data, access a user account, conduct a financial transaction, purchase a product or service, and/or perform other types of secure or sensitive actions. In these login cases, the secure online terminal 18 may provide a login entry field to the user device 16 and a prompt for the user to request an OTP. The secure online terminal 18 generates the OTP and sends it to a device associated with the user (e.g., a registered mobile phone). The user may then type in the OTP into the field and complete this stage of the login process.

However, according to the embodiments of the present disclosure, alternative strategies for authenticating the user are provided. For example, the trusted system 14 is configured to onboard both the user devices 16 and secure online terminals 18 by downloading software or firmware to the devices to enable a facial identification strategy in which the user poses in front of a camera, which is associated with the user device 16, and allows the user device 16 to capture a sequence of facial expressions. These facial expressions (in a particular sequence) are configured to be used as a passcode that can be compared with pre-stored facial expressions (already created with the help of the user). If the sequence of images substantially matches the pre-stored images, then the passcode is considered to be valid and the user device 16 can then proceed with entry into or access of the secure online terminal 18.

### Processing Systems

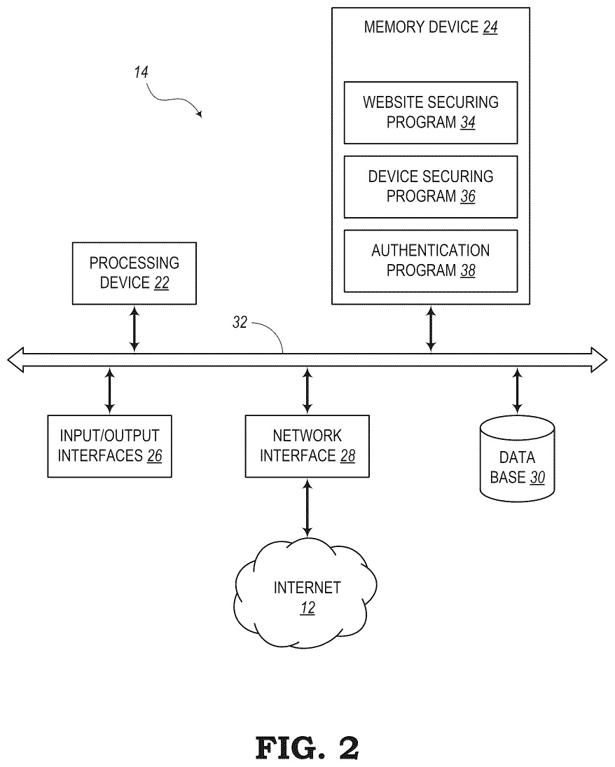

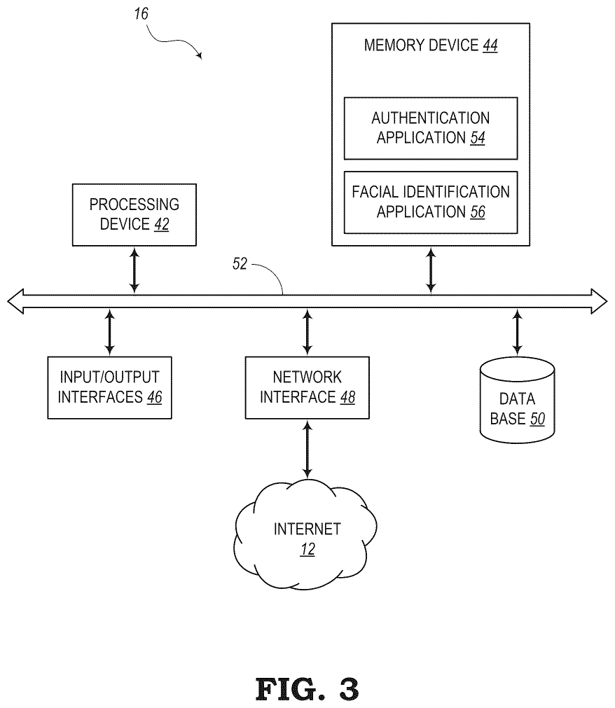

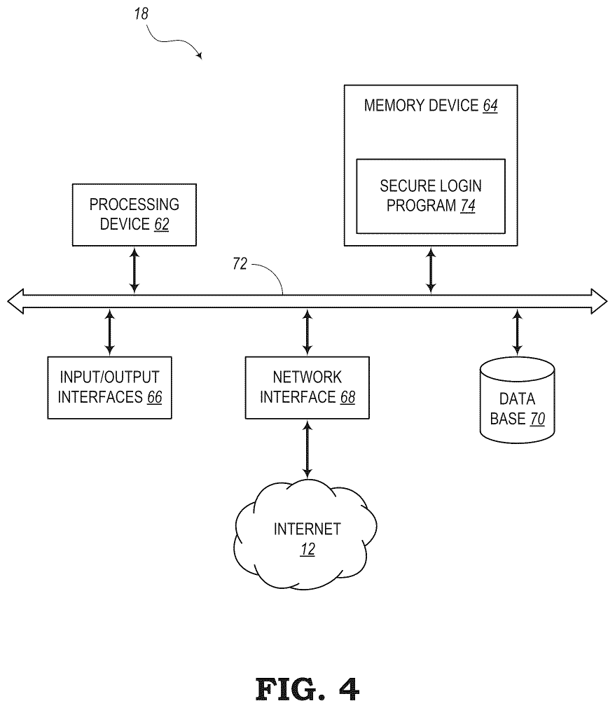

FIG. 2 is a block diagram illustrating an embodiment of the trusted system 14 shown in FIG. 1. FIG. 3 is a block diagram illustrating an embodiment of any one or more of the user devices 16 shown in FIG. 1. Also, FIG. 4 is a block diagram illustrating an embodiment of any one or more of the secure online terminals 18 shown in FIG. 1. In these embodiments, the trusted system 14, user devices 16, and secure online terminals 18 may be configured as processing systems or digital computing systems.

The digital computing systems of FIGS. 2-4, in terms of hardware architecture, may each generally include a processing device 22, 42, 62, a memory device 24, 44, 64, Input/Output (I/O) interfaces 26, 46, 66, a network interface 28, 48, 68, and a data base 30, 50, 70 (or data store). It should be appreciated by those of ordinary skill in the art that FIGS. 2-4 depict the digital computing systems in an oversimplified manner, and a practical embodiment may include additional components and suitably configured processing logic to support known or conventional operating features that are not described in detail herein. The respective processing device 22, 42, 62, memory device 24, 44, 64, I/O interface 26, 46, 66, network interface 28, 48, 68, and data base 30, 50, 70 of each of the trusted system 14, user device 16, and secure online terminal 18, respectively, are communicatively coupled via a local interface 32, 52, 72, respectively. The local interfaces 32, 52, 72 may be, for example, but not limited to, one or more buses or other wired or wireless connections, as is known in the art. The local interface 32, 52, 72 may have additional elements, which are omitted for simplicity, such as controllers, buffers (caches), drivers, repeaters, and receivers, among many others, to enable communications. Further, the local interface 32, 52, 72 may include address, control, and/or data connections to enable appropriate communications among the aforementioned components.

The processing device 22, 42, 62 is a hardware device for executing software instructions. The processing device 22, 42, 62 may be any custom made or commercially available processor, a Central Processing Unit (CPU), an auxiliary processor among several processors associated with the digital computing system, a semiconductor-based microprocessor (in the form of a microchip or chipset), or generally any device for executing software instructions. When the digital computing system is in operation, the processing device 22, 42, 62 is configured to execute software stored within the memory device 24, 44, 64, to communicate data to and from the memory device 24, 44, 64, and to generally control operations of the digital computing system pursuant to the software instructions. The I/O interfaces 26, 46, 66 may be used to receive user input from and/or for providing system output to one or more devices or components.

The network interface 28, 48, 68 may be used to enable the digital computing system to communicate on a network, such as the Internet. The network interface 28, 48, 68 may include, for example, an Ethernet card or adapter or a Wireless Local Area Network (WLAN) card or adapter. The network interface 28, 48, 68 may include address, control, and/or data connections to enable appropriate communications on the network. A data base 30, 50, 70 may be used to store data. The data base 30, 50, 70 may include volatile memory elements (e.g., random access memory (RAM, such as DRAM, SRAM, SDRAM, and the like)), nonvolatile memory elements (e.g., ROM, hard drive, tape, CDROM, and the like), or combinations thereof.

Moreover, the data base 30, 50, 70 may incorporate electronic, magnetic, optical, and/or other types of storage media. In one example, the data base 30, 50, 70 may be located internal to the digital computing system, such as, for example, an internal hard drive connected to the local interface 32, 52, 72 in the digital computing system. Additionally, in another embodiment, the data base 30, 50, 70 may be located external to the digital computing system such as, for example, an external hard drive connected to the I/O interfaces 26, 46, 66 (e.g., SCSI or USB connection). In a further embodiment, the data base 30, 50, 70 may be connected to the digital computing system through a network, such as, for example, a network-attached file server.

The memory device 24, 44, 64 may include volatile memory elements (e.g., random access memory (RAM, such as DRAM, SRAM, SDRAM, etc.)), nonvolatile memory elements (e.g., ROM, hard drive, tape, CDROM, etc.), or combinations thereof. Moreover, the memory device 24, 44, 64 may incorporate electronic, magnetic, optical, and/or other types of storage media. Note that the memory device 24, 44, 64 may have a distributed architecture, where various components are situated remotely from one another but can be accessed by the processing device 22, 42, 62. The software in memory device 24, 44, 64 may include one or more software programs, each of which includes an ordered listing of executable instructions for implementing logical functions. The software in the memory device 24, 44, 64 includes a suitable Operating System (O/S) and one or more programs. The O/S essentially controls the execution of other computer programs, such as the one or more programs, and provides scheduling, input-output control, file and data management, memory management, and communication control and related services. The one or more programs may be configured to implement the various processes, algorithms, methods, techniques, etc. described herein.

The memory device 24 of the trusted system 14 may be configured to store a website securing program 34, a device securing program 36, and an authentication program 38. The programs 34, 36, 38 of the trusted system 14 may enable the trusted system 14 to perform various actions to onboard the user devices 16 and secure online terminals 18 to allow them to conduct the authentication strategies discussed in the present disclosure.

The memory device 44 of the user device 16 may be configured to store an authentication application 54 and a facial identification application 56, whereby either or both of the applications 54, 56 may be downloaded from the trusted system 14. The authentication application 54 and facial identification application 56 may be configured to enable the user device 16 to perform the authentication strategies discussed in the present disclosure.

The memory device 64 of the secure online terminal 18 may be configured to store a secure login program 74, which may be downloaded from the trusted system 14. The secure login program 74 may be configured to enable the secure online terminal 18 to perform the authentication strategies discussed in the present disclosure.

Of note, the general architecture of the digital computing systems can define any device described herein. However, the digital computing system is merely presented as an example architecture for illustration purposes. Other physical embodiments are contemplated, including virtual machines (VM), software containers, appliances, network devices, and the like.

In an embodiment, the various techniques described herein can be implemented via a cloud service. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

### Security Process

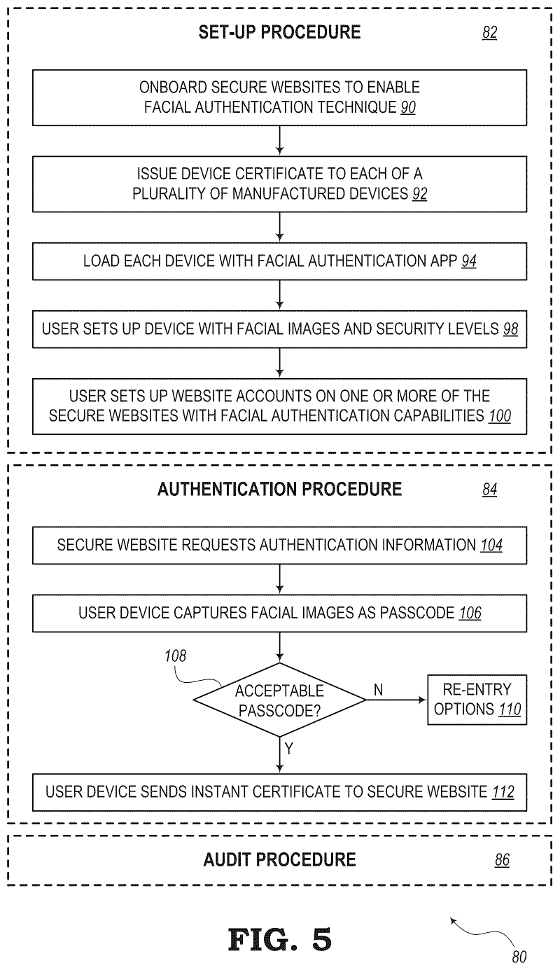

FIG. 5 is a flow diagram illustrating an embodiment of an overall security process 80. As shown in FIG. 5, the overall security process 80 may generally include a set-up procedure 82, an authentication procedure 84, and an audit procedure 86. The set-up procedure 82 may be performed before and immediately after a user purchases a user device 16 to be equipped with the facial identification authentication processes described in the present disclosure. After the set-up procedure 82, the authentication procedure 84 may be performed to allow the user to log into or access a secure online terminal 18 or related user account. The authentication procedure 84 can be conducted at each login attempt and may be used as a supplement to other authentication methods and/or may be used as a replacement for other authentication methods. Also, during attempts to log in using the facial image authentications methods described herein, the trusted system 14 and/or secure online terminals 18 may be configured to store information (e.g., dates, times, identification information of user devices, captured images, etc.). This information can then be gathered together to enable the auditing procedure 86 for determining the effectiveness of the facial authentication processes.

The set-up procedure 82, as illustrated, may include a process of onboarding one or more secure websites (e.g., secure online terminals 18) to enable the facial authentication technique, as indicated in block 90. The set-up procedure 82 also includes issuing a device certificate to each of a plurality of manufactured devices (e.g., user devices 16), as indicated in block 92. The device certificate may be used to verify that the user device is a legitimate device and meets certain standards or protocols. It may be noted that the steps indicated in blocks 90 and 92 may be performed in either order, in an interweaved manner, simultaneously, or other suitable sequence.

After the manufactured devices are issued device certificates (block 92), the set-up procedure 82 further includes a step of loading each device (e.g., user device 16) with a facial authentication app (e.g., authentication application 54 and/or facial identification application 56), as indicated in block 94. The facial authentication app may be configured to allow a user to capture images (e.g., selfies) using a camera associated with the device (e.g., laptop, tablet, smart phone, etc.). It may be noted that the step associated with block 94 may be performed before, after, or simultaneously with block 92.

After a user purchases the user device, which has been issued with the device certificate and is equipped with the facial authentication app, the user can set up the device with facial images and security levels, as indicated in block 98. The facial authentication app may be configured to lead the user through the steps to set-up of the facial identification feature. The app may allow the user to capture multiple images (e.g., selfies) using different poses or facial expressions. Some examples of possible facial expressions may include happy, sad, mad, angry, neutral, frustrated, exhausted, bored, serious, head turned to one side, head tilted forward or backward, mouth open, smiling, frowning, lips puckered, deep in thought, eyes wide open, one eye closed, eyes pointed to one side or the other, and/or any other types of expressions, poses, etc.

Block 98 may also include sorting through the multiple images and picking out certain images that the user may wish to use in the facial identification feature. The user may set one or more security levels for different authentication situations. For example, a simple action (e.g., turning on a smart phone) may involve using a single facial expression to allow the user to meet the specific security. The user may also choose a low security level, which may include a sequence of two or more images using different facial expressions. This low security level may be used for logging on to certain websites that might not involve a serious threat of loss, which may include, for instance, social media websites, blogs, etc. Also, the user may wish to create one or more higher security passcodes using a larger number of facial images. For example, higher security passcodes may be used for logging onto banking websites, financial transaction websites, product and service purchasing websites, etc. Furthermore, the user may be able to use any desired sequence of images for each of the passcodes having two or more images. If a passcode is configured to include three images, the user may select, for example, a sequence of a sad face, an angry face, and then a surprised face.

The next step in the set-up procedure 82 includes the user setting up various website accounts on one or more of the secure websites (e.g., secure online terminals 18) that are also equipped with the facial authentication capabilities (e.g., secure login program 74). The secure websites may have their own requirements for security and may be configured to request a passcode that includes at least a certain number of facial expressions (e.g., at least six) to login or access an account.

Once the user device 16 and secure online terminals 18 have been onboarded by the trusted system 14 for using the facial identification system, the user can then use the system to log onto any of the associated secure online terminals 18 using the facial identification methods. That is, the authentication procedure 84 includes a first step (block 104) of the secure website requesting authentication information. In some embodiments, the secure website might request the facial image authentication information as part of a multi-step authentication procedure. In other embodiments, the secure website may offer the facial image authentication option as an alternative to one or more other authentication methods, such as a replacement for an OTP procedure.

The authentication procedure 84 next includes the user responding to the request (block 104) by allowing the user device to capture current facial images of the user to be used as a passcode, as indicated in block 106. The authentication procedure 84 then includes the step of performing a facial recognition process to determine if the passcode (e.g., sequence of facial images) is acceptable, as indicated by the decision block 108. According to various embodiments, the comparison of the new (or current) facial images taken during the login process with the images that were pre-stored during the set-up procedure 82 can be performed by the authentication application 54 and/or facial identification application 56 associated with the user device 16 itself, using the pre-approved downloaded applications 54, 56 from the trusted system 14. In other embodiments, the newly captured user images may be transmitted to the trusted system 14 to perform the comparison procedure.

If the passcode if found in decision block 108 not to be acceptable (i.e., the current images do not substantially match the pre-stored images), then the authentication procedure 84 proceeds to block 110, which may include a chance for the user to capture a new sequence of facial images for comparison with the pre-stored images. Block 110 may include other re-entry options as well, such as providing suggestions to the user to capture a better set of images. It may be noted that certain issues may be experienced when catching the images, which might lead to rejection of the images as a legitimate passcode. For example, the camera may distort the images if the user's face is too close or too far away or if the images are blurry, too dark, etc. Also, the user's head may be tilted too far to one side or may not accurately reproduce a previously stored expression. Other problems may include the user growing facial hair, a change of glasses or sunglasses, the user having a facial injury with swelling, lacerations, black eye, scar, etc. Another problem with matching may be that a user may have gained or lost a considerable amount of weight from the time when the original set-up images were taken. Also, issues with image matching may be the result of the user wearing clothing (e.g., hat, scarf, ear muffs, ghoonghat, balaclava, ski mask, jacket, etc.) that covers part of the user's face. These and/or other issues may arise and cause issues with matching a pre-stored set of images. In some cases, the authentication application 54 may be configured to make recommendations (e.g., “Please remove your hat.”) in an attempt to correct one or more issues.

If it is determined in decision block 108 that the current images match the pre-stored images to an acceptable degree, then the authentication procedure 84 proceeds to block 112. At this point, the user device 16 sends an instant certificate to the secure website that serves as an acceptable method to gain access to the website or account. The instant certificate may be created by the trusted system 14 during the onboarding and set-up procedures for the user devices 16 and secure online terminals 18. In some embodiments in which the trusted system 14 is configured to perform the image comparison task, the trusted system 14 may send the instant certificate to the secure website for authorization.

In addition, the security process 80 may further include the audit procedure 86. During one or more attempts to login or gain secure access (i.e., during authentication procedure 84 attempts), whether successful or unsuccessful, the trusted system 14, user device 16, and/or secure online terminal 18 may be configured to record information about the attempts. For example, this information may include time and date information, user device information (e.g., MAC address), geolocation of user device during access attempts, images (and video) of the user captured by the related camera during the attempts, etc. From this information, a further analysis may be performed to determine if a hacker has attempted to impersonate a legitimate user, if a hacker has attempted to use a photograph of the user to attempt to login, the success of the image capture processes, etc.

The audit procedure 86 may be performed after one or more successful transactions have been completed. Just like a website may store “the entered OTP from the User,” “number of bad attempts,” “event date time,” etc. in their database for future auditing purposes, the websites, similarly, can store uploaded Instant Certs for future reference purpose for a limited amount of time (e.g., 1 month). In this case, the website may include memory or a database for storing the Instant Certs (in at least one column of a table). The information may be used to provide transparent auditing capability for any fraudulent financial activity or scam activity.

### Facial Identification Images

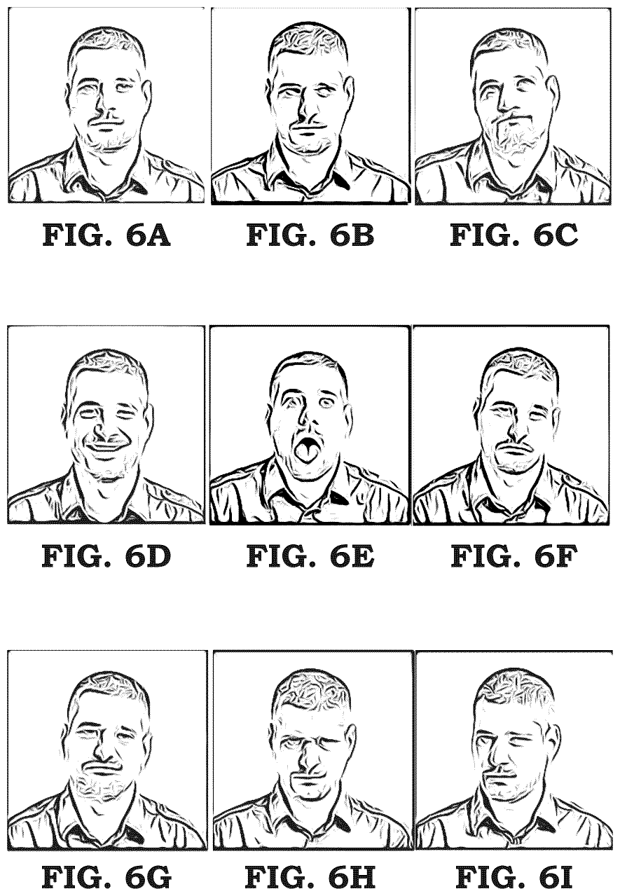

FIGS. 6A-6I are example images of a user illustrating a number of different facial expressions that might be used for creating one or more facial authentication passcodes. As shown, FIG. 6A shows a captured image of a “neutral” or “indifferent” facial expression, FIG. 6B shows a captured image of a “cautious” facial expression, FIG. 6C shows a captured image of a “disappointed” facial expression, FIG. 6D shows a captured image of a “happy” facial expression, FIG. 6E shows a captured image of a “silly” facial expression, FIG. 6F shows a captured image of a “sad” facial expression, FIG. 6G shows a captured image of a “frustrated” facial expression, FIG. 6H shows a captured image of a “mad” facial expression, and FIG. 6I shows a captured image of a “suspicious” facial expression. In some embodiments, the set-up procedure 82 may include prompting for the user to capture these and/or other types of facial expressions.

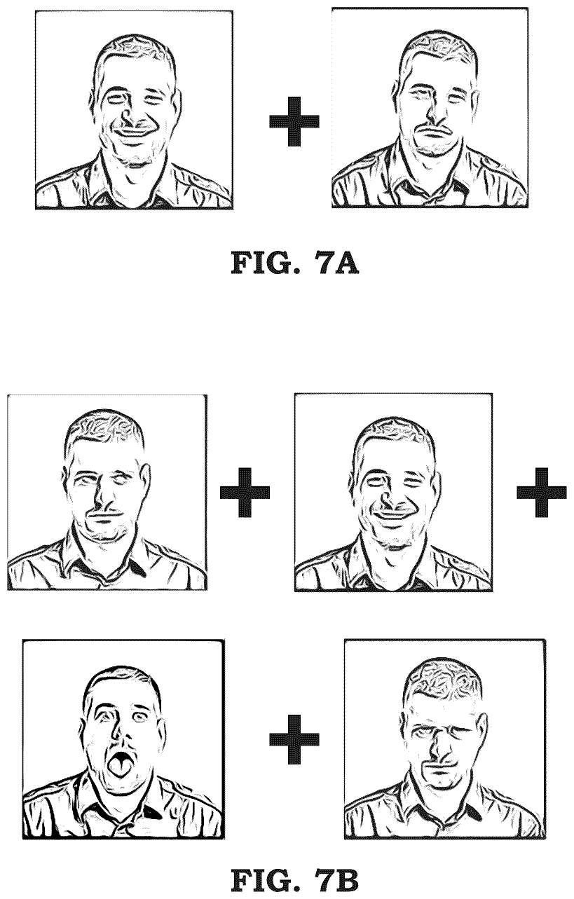

FIGS. 7A and 7B are combinations of different facial expressions for creating different facial authentication passcodes or profiles that can be used for creating different levels of security. FIG. 7A includes a combination of a happy face (FIG. 6D) and a sad face (FIG. 6F). These two facial expressions may be combined in this particular sequence to form a first facial authentication passcode or profile. Thus, for secure websites that may require a low level of security, the combination of FIG. 7A may be used. In FIG. 7B, a profile (or facial authentication passcode) is created using four facial images and is therefore considered to be more secure and may be more appropriate for higher security situations (e.g., banking, financial, purchasing, etc.). As shown, FIG. 7B includes a sequence of a cautious face (FIG. 6B) plus a happy face (FIG. 6D) plus a silly face (FIG. 6E) plus a mad face (FIG. 6H). These and other various combinations of images with any suitable number of images and any suitable sequence may be used for creating any number of facial passcodes/profiles for various security levels.

### Login Fields

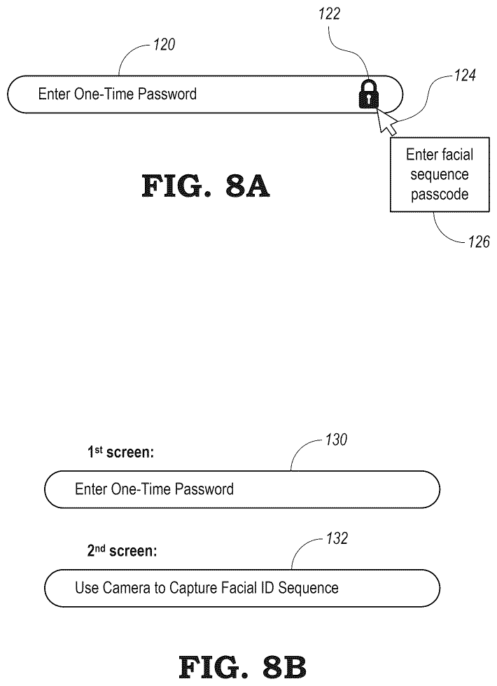

FIGS. 8A and 8B are diagrams illustrating login fields for performing different types of authentication procedures. FIG. 8A shows a login field 120 that requests a user to enter a One-Time Password (OTP). In this embodiment, the user may request that an OTP is sent to his or her related device (e.g., mobile phone) and the user can enter that OTP into the login field 120. Alternatively (e.g., if the user does not have his or her mobile phone nearby), the user may click on an icon 122, which may have a symbol of a lock, a face, etc. By using a computer mouse pointer 124 (or by tapping on an interactive screen using the user's finger), the user can select the alternative option. In some embodiments, a text box 126 may be displayed giving instructions to the user for using the alternative method (e.g., capturing of a facial image sequence).

FIG. 8B is a diagram illustrating another method for authenticating a user. In this embodiment, the user goes through a two-step process. The two-step process may include the use of a first field 130 in which the user enters the OTP and a second field 132 in which the user is instructed to use his or her camera to capture the facial ID sequence.

### Authentication Process

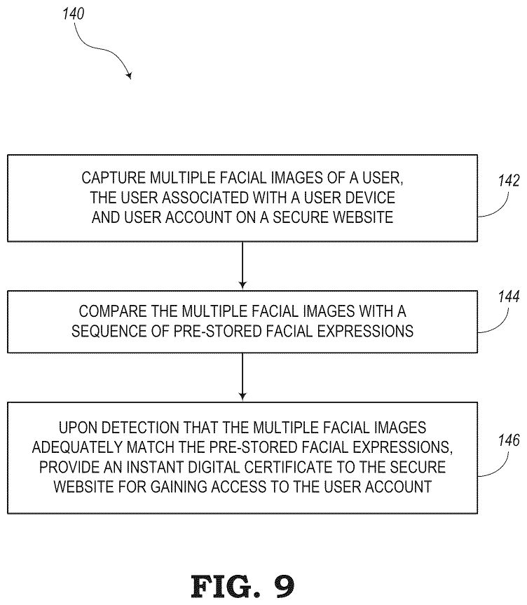

FIG. 9 is a flow diagram illustrating an embodiment of a process for authenticating a user for accessing a secure website. The user authentication process 140 is configured to enable a user device to gain access to a user account on a secure website. As shown, the user authentication process 140 includes a step capturing multiple facial images of a user associated with the user device and user account, as indicated in block 142. The user authentication process 140 further includes a step of comparing the multiple facial images with a sequence of pre-stored facial expressions. Upon detection that the multiple facial images adequately match the pre-stored facial expressions, the user authentication process 140 includes a step of providing an instant digital certificate to the secure website for gaining access to the user account. In some embodiments, the user authentication process 140 may be performed in lieu of a one-time password procedure (FIG. 8A) conducted between the secure website and user device.

According to various embodiments of the user authentication process 140, the pre-stored facial expressions may be captured during a set-up procedure (e.g., set-up procedure 82). The set-up procedure, for example, may enable the user to select a number of images to be included in the sequence and a type of facial expression for each image. In some implementations, the set-up procedure includes coordination among a Certificate Authority, the user device, and the secure website. The Certificate Authority, for example, may be configured to a) onboard the secure website to enable facial authentication processing, b) issue a device certificate to the user device, and c) load a facial authentication application on the user device to enable the facial authentication processing with the secure website. The set-up procedure may further enable the user to create multiple security passcodes, where each security passcode may include a different number and/or sequence of images. Also, the multiple security passcodes enable the user to open the user device itself as well as access one or more secure websites. The set-up procedure may further enable the user to bind personal information with the user account during a registration procedure, where the personal information may include one or more of a mobile number and an email address.

Furthermore, the user authentication process 140 according to various embodiments may be configured such that a trusted Certificate Authority may be configured to download an authentication application to the user device to enable the user device to a) capture the sequence of pre-stored facial expressions during a set-up procedure, and b) capture the multiple facial images during a login procedure. The authentication application may further enable the user device to c) compare the multiple facial images with the sequence of pre-stored facial expressions, d) detect whether the multiple facial images adequately match the pre-stored facial expressions, and e) provide the instant digital certificate to the secure website.

The user authentication process 140 may further include the steps of a) collecting information regarding successful and unsuccessful attempts to access the user account, and b) analyzing the information to detect malicious behavior. In some embodiments, the step of capturing multiple facial images of the user may include capturing a video of the user to determine that the user is a real person. Therefore, the step of comparing the multiple facial images with the sequence of pre-stored facial expressions may include the steps of a) comparing multiple images extracted from the video with each pre-stored facial expression until a match is detected, and b) repeating the comparing step with a next pre-stored facial expression in the sequence until all pre-stored facial expressions are matched.

The user authentication process 140 contemplates implementation as a method having steps, via a processing device in a smart device configured to implement the steps, and via a non-transitory computer-readable medium storing instructions for programming one or more processors to execute the steps.

### Smartphone Capabilities

Nowadays, smartphones have become powerful in terms of hardware (e.g., camera, RAM, processor, etc.) so that many mobile applications are able to do a portion of the hardware intensive processing (e.g., Machine Learning (ML), Artificial Intelligence (AI), etc.) that might normally be performed, in the past, by a server. Some smartphones may have facial unlock features, which can require a good amount of processing/analyzing to determine whether to unlock the smartphone for the given input of an image of the face of the user.

Regarding the login and authentication stages, the systems and methods of the present disclosure are configured to provide a better and faster user experience. In some cases, the methods described herein may replace OTP mechanisms or may serve as an added security component. As an alternative to OTP procedures, the systems and methods of the present disclosure may be incorporated into daily authentication processes while using smartphones, tablets, laptops, or any other suitable type of personal computing device having a camera. Again, the user device may include a device certificate issued by a CA and may include a processing of scanning multiple images of various facial expressions of the legitimate user.

The user device 14 (e.g., smartphone) may include two or more sets of face identifier image sets stored in memory. A first face identifier can be used at a lower security setting, and it can be used for regular phone unlocking use cases by simply scanning the face with single expression. The second (and additional) face identifier image sets may be generated with higher security and may therefore include more images and use more complex comparison steps. These image sets can be used for online payment approvals or wherever OTP verification is requested. To generate the second (and additional) face identifier sets, the user may scan his or her face with two or more different expressions, as is shown in the sample images of FIGS. 6A-6I.

Also, the user can set up various options and security settings. A low security setting may include a single expression, such as for unlocking the smartphone. A medium security setting may include two or more expressions, such as for unlocking a social media account, email account, etc. A high security setting may include multiple expressions (e.g., four or more), such as for unlocking banking apps, financial transaction services, medical data transfer, apps that reference the user's SSN or other important personal information, etc.

Binding Facial Identification Information with Email ID and Mobile Number

After setting up “multi expression facial identifier,” the user may bind an email ID or account, a mobile phone number, and/or other personal information with the facial identifier using OTP verification on entry of both the email information and mobile phone information. This OTP verification may be a one-time activity for setting up or registering the smartphone. After the set-up procedure 82, the user may be able to authenticate his or her identity and/or bypass the OTP verification process in a website's user account wherever that same email ID and mobile phone number are registered.

### Device Certificates and Instant Certificates

Smartphone vendors may wish to buy a Device Certificate (i.e., cert1) from the trusted system 14 or any reputed Certificate Authority (e.g., DigiCert). The Device Certificate can have detailed information about the specific smartphone, such as International Mobile Equipment Identity (IMEI) number, build date, model number, basic hardware information, camera specifications, etc. The device manufacturer can install the cert1 in the smartphone even before it is sold to the end user. Each smartphone may typically have one unique Device Certificate (cert1) that is signed by trusted system 14 (e.g., DigiCert).

In some embodiments, the smartphone may also have a pre-loaded app (e.g., authentication application 54) from the trusted system 14 or may download it at any time. The app may be configured to generate short-lived “Instant Certificates,” which might expire, for example, after about five minutes.

Whenever the user sees any OTP verification in a webpage of a participating online server and/or whenever the facial ID authentication is available, the user can lock the screen of the smartphone (or other user device) and then unlock the smartphone with a “Multi Expression Facial Unlock” procedure. This activity may be configured to generate an “Instant Certificate” that is automatically uploaded to the webpage that the user device is currently open to. The user can then proceed from the OTP verification page to a Next Page automatically. One Instant Certificate may be generated if the user presses the Lock screen button and then may immediately unlock the smartphone with the Multi Expression Facial Unlock.

The Instant Certificate can be signed by the pre-loaded app previously downloaded by the trusted system 14 or CA. This app may include:
a date and time of a 1st expression posed by user
a date and time of a 2nd expression posed by user (even with a milli-second difference)
a date, time, and geo-location of the device unlocked
a percentage of match of 1st expression (supplied by device)
a percentage of match for 2nd expression (supplied by device)
registered email ID and/or mobile phone number of the user
certificate serial number of cert1 (original device certificate)
signed by trusted system 14 or CA ID (e.g., DigiCert)
Unique Reference ID for the current webpage

In many cases, the same Instant Cert cannot be used for more than one occurrence. If any website uses multiple webpages to finish one transaction and the OTP verification is placed at multiple pages, then the user may need to do the “Lock-Unlock” activity for each OTP verification occurrence. The Instant Cert may be small in size as it will not contain extra details about the device. However, it may include a link for linking the user device to the original Device Cert, which may include the necessary device information. Bypassing OTP verification and Captcha verification in any of these websites can therefore be done using the Instant Certification process.

### Keeping Records of Successful Authentication on a Website's Database

Using the User Facial Image ID Authentication may have certain advantages over OTP verification. For example, if a hacker is able to do a SIM-swap of the user, the hacker can reset the password using OTP verification under the conventional paradigm. The hacker may also perform a financial transaction using more OTP verification. However, this is not possible with the embodiments described in the present disclosure. Even though a SIM-swap may happen if the user disables OTP verification for all his online accounts and replaces them with the strategies of the present disclosure, then activities like Password Reset, Stealing Money, etc. will still not be possible by the hacker.

Furthermore, auditing any Online Transaction becomes easier and more resourceful. With the help of Instant Certs, the present embodiments can get so much extra details, like Device Unlock Timestamp, Geo-Location, Percentage of Face match for each Pose, etc. If the User does not want to bypass the OTP/Captcha verification and he or she wants to keep using simple (but low security) OTP verification, then they can manually input the code into the OTP Textbox (bypassing, in this case, OTP/Captcha is optional).

### Additional Security Restrictions

The User may want to keep Regular Security settings (Single Expression Facial Unlock) for all the time and want to enable High Security settings (Multi Expression Facial Unlock) only during Online Payments. Whenever the Smartphone gets locked due to certain minutes (or seconds) of inactivity, it can be unlocked with the “Single Expression Facial Unlock” feature.

And whenever User clicks the Lock button in the smartphone, it will automatically require “Multi Expression Facial Unlock” for the immediate next Unlock activity. Hence, during Online Payments/Transactions, User can activate the “High Security Settings” by clicking the Lock button in the smartphone.

In some embodiments, the User might not be able to add multiple Email IDs and Mobile Numbers with the same “Multi Expression Facial Identifier.” However, User can change Email ID Or Mobile Number by redoing OTP verification once more.

If User has multiple Email ID and Mobile Number combinations in different Websites, Bank Accounts, etc., then User may need to setup a Second “Multi Expression Facial Identifier” with different Expression combinations and bind it with different Email IDs and Mobile numbers. According to some examples, Bob may have the following two combinations of email identifications and mobile numbers:
1) bob@gmail.com; mobile no. (901) 234-5890; registered at Amazon, Zomato, Bank of America; using the Facial Identifier Passcode shown in FIG. 7A; and
2) bob123@yahoo.com; mobile no. (901) 234-5890; registered at Netflix, Uber, Citi Bank; using the Facial Identifier Passcode shown in FIG. 7B

In this example, User has reused some of the same Facial Expressions, but the sequence (chronology) may have changed, the number of images may have changed, the types of poses or expressions may have changed, etc. If User wants to create more than one “Multi Expression Facial Identifier” (MEFI), User can choose completely different expressions for the second or subsequent MEFIs. Just like with other password strategies, User may need to remember different Username & Password combination for different Email IDs, accounts, etc. Similarly, User needs to remember his Facial Identifier sequence, number of images, and types of poses/expressions associated with each Email ID.

During the set-up procedure 82, the related apps may be configured to lead the user through the initial image capture process. The user may be prompted to “Do expression one,” and then, “Do expression two.” It may be noted that a hacker may not know what types of expressions are used and the order in which they are incorporated into the Facial ID Authentication passcode.

In some embodiments, the comparison between currently obtained images with the pre-stored user ID images may include proceeding from one comparison to another. Once a first match (e.g., sad face with pre-stored sad face) is detected, the app may present a beeping sound or other indication that this one match has been made and the user can go onto the next image. Then, the analysis compares the current images with the pre-stored image (e.g., frustrated face with pre-stored frustrated face). The analysis goes through each image in sequence and may give feedback to the user that matches were detected. Once the full sequence of the particular Facial ID pattern is complete, the account or website can be unlocked.

The steps may include immediately detecting back-to-back expressions within a certain timeframe (e.g., minimal amount of about 2 or 3 seconds). If within that period, if user is able to capture the particular pose or expression, then the smartphone will be unlocked and/or the website can be accessed. Also, the Instant Certificate may be triggered, which may have data about the entire authentication event, like the timestamp, geolocation stamp, etc. And this particular instance served will actually be uploaded to that particular app or website, which is seeking the OTP-based mechanism.

Whenever the Instant Cert is generated, the trusted system 14 or CA app may automatically push it to whatever app the user is currently using and has in the front of the screen. This will get uploaded, and immediately the user may resume with whatever task he or she was trying to perform (e.g., a payment activity), which at this time is approved by that particular app.

Auditing capabilities are possible in this environment but are not possible with typical OTP, because in the typical OTP cases, the database has just multiple failed OTP items and only a timestamp. But, in this case, the system may have a lot of extra data about a malicious user who may have tried to unlock some payment activity with some different face, a different geolocation, etc. and a lot of extra data can be saved in the database for future auditing and used to investigate any malicious activity, man-in-the-middle attacks, etc.

### X509 Certificate

A certificate authority is an entity that stores, signs, and issues digital certificates. This allows others (relying parties) to rely upon signatures or on assertions made about the private key that corresponds to the certified public key. A CA acts as a trusted third party-trusted both by the subject (owner) of the certificate and by the party relying upon the certificate. For certificate authorities, existing individual validation processes involve the use of third-party verification services to validate basic individual information such as first name, last name, professional title, etc. However, these processes do not include the option to validate and incorporate an individual's crypto wallet address. As cryptocurrency becomes more prevalent, there is an increasing need for a secure, verified method of associating crypto wallet addresses with individuals.

Again, the present disclosure includes wallet information in an X509 certificate that is issued from a trusted certificate authority. For example, the wallet information can be included in the Subject Alternative Name (SAN) field of an X509 certificate. The present disclosure enhances the existing individual validation process by incorporating the option for an individual to supply a crypto wallet address. This address is captured, validated, and stored in a database along with the individual's basic information. An X509 personal certificate containing all the individual information, as well as the wallet address, is then generated, which can be used to sign digital content.

X509 certificates are defined by ITU X509, Information technology—Open Systems Interconnection—The Directory: Public-key and attribute certificate frameworks, October 2019, the contents of which are incorporated by reference in their entirety. An X509 certificate binds an identity to a public key using a digital signature. A certificate contains an identity (a hostname, or an organization, or an individual) and a public key (e.g., RSA, DSA, ECDSA, ed25519, etc.), and is signed by a certificate authority. X509 also defines certificate revocation lists, which are a means to distribute information about certificates that have been deemed invalid by a signing authority, as well as a certification path validation algorithm, which allows for certificates to be signed by intermediate CA certificates, which are, in turn, signed by other certificates, eventually reaching a trust anchor.

When a certificate is signed by a trusted certificate authority, or validated by other means, someone holding that certificate can use the public key it contains to validate documents or content digitally signed by the corresponding private key.

In an embodiment, an X509 certificate can be used to digitally sign content. A content signing certificate allows individuals, teams, and organizations to add an electronic, digital signature to a document or other content in a variety of file formats to prove ownership. The digital signature is an encrypted hash of your message that can only be decrypted by someone who has a copy of your public key, which ensures (1) content stays unaltered, (2) the creator's identity is confirmed, and the like.

A digital signature cryptographically binds a digital signature certificate, issued by a trust services provider (TSP), to a document using public key infrastructure (PKI) technology. Digital signatures validate and authenticate signer identity and document integrity, delivering higher levels of assurance that the signer is who they say they are and that the document has not been altered. Digital signatures are ideal for transactions that require higher level of security and are necessary in certain countries and regions where companies are required to comply with legal regulations. In some countries, some forms of digital signatures have legal validity equivalent to handwritten signatures.

In another embodiment, the X509 certificate can be referred to as a personal certificate, i.e., it does not necessarily need to be used to digitally sign content. In a further embodiment, the X509 certificate can be a content credential that includes history and identity data attached to content. A user can view this data when a creator or producer has attached it to content to understand more about what has been done to it, where it has been, and who is responsible. Content credentials are public and tamper-evident, and can include info like edits and activity, assets used, identity info, and more.

### CONCLUSION

It will be appreciated that some embodiments described herein may include one or more generic or specialized processors (“one or more processors”) such as microprocessors; central processing units (CPUs); digital signal processors (DSPs): customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a read-only memory (ROM), a programmable read-only memory (PROM), an erasable programmable read-only memory (EPROM), an electrically erasable programmable read-only memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

What is claimed is:

1. A user authentication method for enabling a user device to gain access to a user account on a secure website, the user authentication method comprising steps of:
capturing multiple facial images of a user associated with the user device and user account;
comparing the multiple facial images with a sequence of pre-stored facial expressions; and
upon detection that the multiple facial images adequately match the sequence of pre-stored facial expressions, providing an instant digital certificate to the secure website for gaining access to the user account.

2. The user authentication method of claim 1, wherein the user authentication method is performed in lieu of a one-time password procedure conducted between the secure website and user device.

3. The user authentication method of claim 1, wherein the sequence of pre-stored facial expressions are captured during a set-up procedure.

4. The user authentication method of claim 3, wherein the set-up procedure enables the user to select a number of images to be included in the sequence and a type of facial expression of each image.

5. The user authentication method of claim 3, wherein the set-up procedure further includes coordination among a Certificate Authority, the user device, and the secure website.

6. The user authentication method of claim 5, wherein the Certificate Authority is configured to:
onboard the secure website to enable facial authentication processing;
issue a device certificate to the user device; and
load a facial authentication application on the user device to enable the facial authentication processing with the secure website.

7. The user authentication method of claim 3, wherein the set-up procedure further enables the user to create multiple security passcodes, each security passcode including a different number and/or sequence of images, and wherein the multiple security passcodes enable the user to open the user device itself as well as access one or more secure websites.

8. The user authentication method of claim 3, wherein the set-up procedure further enables the user to bind personal information with the user account during a registration procedure, the personal information including one or more of a mobile number and an email address.

9. The user authentication method of claim 1, wherein a trusted Certificate Authority is configured to download an authentication application to the user device to enable the user device to:
capture the sequence of pre-stored facial expressions during a set-up procedure; and
capture the multiple facial images during a login procedure.

10. The user authentication method of claim 9, wherein the authentication application further enables the user device to:
compare the multiple facial images with the sequence of pre-stored facial expressions;
detect whether the multiple facial images adequately match the sequence of pre-stored facial expressions; and
provide the instant digital certificate to the secure website.

11. The user authentication method of claim 1, further comprising steps of:
collecting information regarding successful and unsuccessful attempts to access the user account; and
analyzing the information to detect malicious behavior.

12. The user authentication method of claim 1, wherein the step of capturing multiple facial images of the user includes capturing a video of the user to determine that the user is a real person.

13. The user authentication method of claim 12, wherein the step of comparing the multiple facial images with the sequence of pre-stored facial expressions includes steps of:
comparing multiple images extracted from the video with each pre-stored facial expression until a match is detected; and
repeating the comparing step with a next pre-stored facial expression in the sequence until all pre-stored facial expressions are matched.

14. A system comprising:
a processing device; and
a memory device configured to store computer logic having instructions that, when executed, enable the processing device to perform steps of:
capturing multiple facial images of a user associated with a user device and user account on a secure website;
comparing the multiple facial images with a sequence of pre-stored facial expressions; and
upon detection that the multiple facial images adequately match the sequence of pre-stored facial expressions, providing an instant digital certificate to the secure website for gaining access to the user account.

15. The system of claim 14, wherein the instructions enable the processing device to perform the steps of capturing, comparing, and providing in lieu of a one-time password procedure conducted between the secure website and user device.

16. The system of claim 14, wherein the sequence of pre-stored facial expressions are captured during a set-up procedure, wherein the set-up procedure enables the user to select a number of images to be included in the sequence and a type of facial expression of each image, and wherein the set-up procedure further includes coordination among a Certificate Authority, the user device, and the secure website.

17. The system of claim 16, wherein the Certificate Authority is configured to:
onboard the secure website to enable facial authentication processing;
issue a device certificate to the user device; and
load a facial authentication application on the user device to enable the facial authentication processing with the secure website.

18. A non-transitory computer-readable medium configured to store computer logic having instructions that, when executed, enable a processing device to perform steps of:
capturing multiple facial images of a user associated with a user device and user account on a secure website;
comparing the multiple facial images with a sequence of pre-stored facial expressions; and
upon detection that the multiple facial images adequately match the sequence of pre-stored facial expressions, providing an instant digital certificate to the secure website for gaining access to the user account.

19. The non-transitory computer-readable medium of claim 18, wherein a trusted Certificate Authority is configured to download an authentication application to the user device to enable the user device to:
capture the sequence of pre-stored facial expressions during a set-up procedure;
capture the multiple facial images during a login procedure;
compare the multiple facial images with the sequence of pre-stored facial expressions;
detect whether the multiple facial images adequately match the sequence of pre-stored facial expressions; and
provide the instant digital certificate to the secure website.

20. The non-transitory computer-readable medium of claim 18, wherein the step of capturing multiple facial images of the user includes capturing a video of the user to determine that the user is a real person, and wherein the step of comparing the multiple facial images with the sequence of pre-stored facial expressions includes steps of:
comparing multiple images extracted from the video with each pre-stored facial expression until a match is detected; and
repeating the comparing step with a next pre-stored facial expression in the sequence until all pre-stored facial expressions are matched.
